(19) United States
(12) Patent Application Publication
(10) Pub. No.: US 2006/0050153 A1
(43) Pub. Date: Mar. 9, 2006

(54) Imaging system and method

(76) Inventor: David W. Boll, Greeley, CO (US)

Correspondence Address: HEWLETT-PACKARD COMPANY;Intellectual Property Administration, P.O. Box 272400, Fort Collins, CO, 80527-2400, US

(21) Appl. No.: 10/988,077

(22) Filed: Nov. 12, 2004

Related U.S. Application Data
(60) Provisional application No. 60/608,301, filed on Sep. 7, 2004.

(51) Int. Cl. H04N 5/225; H04N 5/262; G06K 9/36; H04N 1/46; G03G 15/00

(52) U.S. Cl. 348/218.1; 348/239; 382/284; 358/540

(57) ABSTRACT

An imaging system comprises an imaging device adapted to capture a plurality of images of an object. The imaging system also comprises a stacking application stored on the imaging device and adapted to generate a stacked image from the plurality of images.

### BACKGROUND

A number of different types of imaging software applications are available to visually enhance images and/or decrease the noise level in digital image data. For example, one such software applications is ADOBE PHOTOSHOP which enables a user of the application to combine or stack images to create a target “stacked” image which generally has an improved signal-to-noise ratio. However, utilizing such software applications is generally a time-consuming and manually demanding process requiring that the user train or otherwise become familiar with the software application as well as perform image alignment operations.

### SUMMARY OF THE INVENTION

In accordance with one embodiment of the present invention, an imaging system comprises an imaging device adapted to capture a plurality of images of an object. The imaging system also comprises a stacking application stored on the imaging device and adapted to generate a stacked image from the plurality of images.

In accordance with another embodiment of the present invention, an imaging method comprises initiating a stacking application stored on an image capturing device and capturing a plurality of images via the image capturing device. The method also comprises generating a stacked image on the image capturing device from the plurality of images via the stacking application.

### BRIEF DESCRIPTION OF THE DRAWINGS

For a more complete understanding of the present invention and the advantages thereof, reference is now made to the following descriptions taken in connection with the accompanying drawings in which:

FIG. 1 is a diagram illustrating an embodiment of an imaging system in accordance with the present invention; and

FIG. 2 is a flow diagram illustrating an embodiment of an imaging method in accordance with the present invention.

### DETAILED DESCRIPTION OF THE DRAWINGS

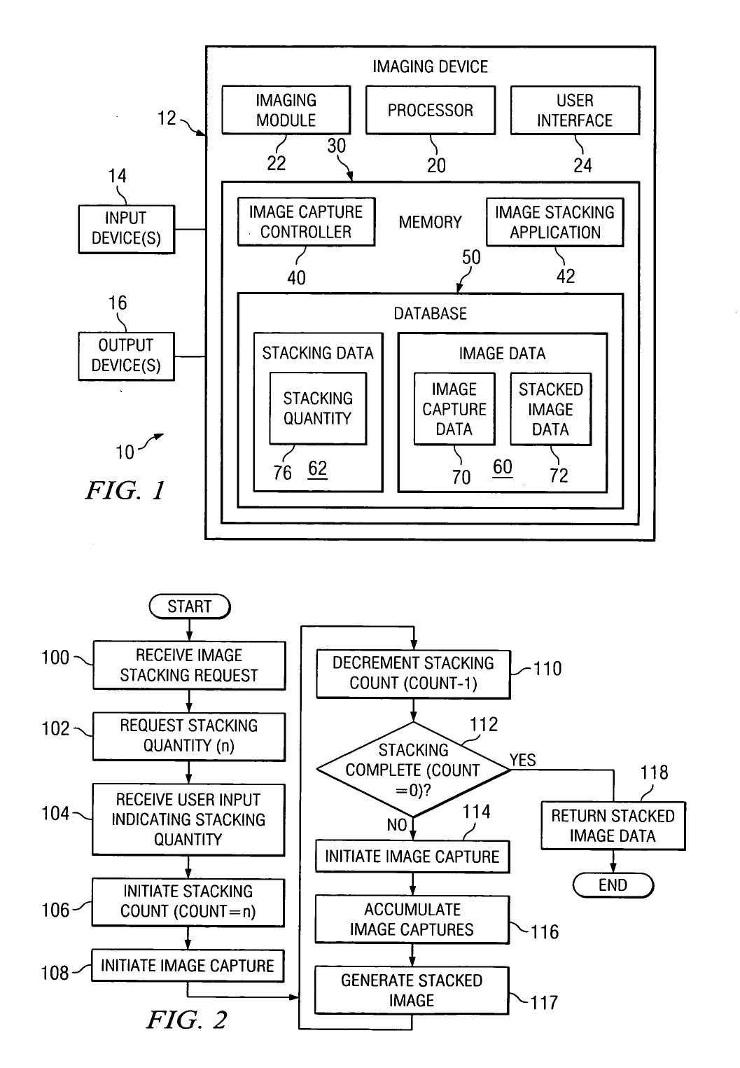

The preferred embodiments of the present invention and the advantages thereof are best understood by referring to FIGS. 1 and 2 of the drawings, like numerals being used for like and corresponding parts of the various drawings.

FIG. 1 is a diagram illustrating an embodiment of an imaging system 10 in accordance with the present invention. In the embodiment illustrated in FIG. 1, system 10 comprises an imaging device 12 for capturing an image of an object. Imaging device 12 may comprise any type of image capturing device such as, but not limited, a scanner, copier, and camera. In the embodiment illustrated in FIG. 1, imaging device 12 is illustrated as being coupled to input device(s) 14 and output device(s) 16. Input device(s) 14 and output device(s) 16 may comprise any type of device for inputting information to imaging device 12 or providing an output of information from imaging device 12, respectively, such as, but not limited to, a memory card, display or printer.

In the embodiment illustrated in FIG. 1, imaging device 12 comprises a processor 20, an imaging module 22, and a user interface 24. Imaging module 22 and user interface 24 may comprise hardware, software or a combination of hardware and software. Imaging module 22 is used to capture an image of an object. For example, imaging module 22 may comprise a scanner carriage, shutter element, photosensitive element array, lens assembly, and/or any other type of mechanism or element used for capturing an image of an object corresponding to a particular type of imaging device 12. User interface 24 is used to receive input from a user of imaging device 12 and/or provide information to the user of imaging device 12 such as, but not limited to, information associated with capturing an image of an object. User interface 24 may comprise a keypad, touch screen display, liquid crystal display (LCD), or any other type of device for providing an interface for user interaction with imaging device 12.

In the embodiment illustrated in FIG. 1, imaging device 12 also comprises a memory 30 having an image capture controller 40 and an image stacking application 42. Image capture controller 40 and image stacking application 42 may comprise software, hardware, or a combination of software and hardware. Image capture controller 40 is used to control capturing of an image using imaging device 12. For example, image capture controller 40 is used to initiate, actuate, or otherwise control imaging module 22 to capture an image of an object using imaging device 12. Image stacking application 42 is used to combine or otherwise stack a plurality of images captured using imaging device 12. As used herein, generating a “stacked” image shall mean blending, compositing, summarizing, averaging, overlaying, or otherwise combining two or more images to create a single image having an increased signal-to-noise ratio.

In the embodiment illustrated in FIG. 1, imaging device 12 also comprises a database 50 in memory 30 comprising image data 60 and stacking data 62. Image data 60 comprises information associated with images captured by imaging device 12 and/or image information resulting from combining or stacking two or more images. For example, as illustrated in the embodiment of FIG. 1, image data 60 comprises image capture data 70 and stacked image data 72. Image capture data 70 comprises information associated with images captured using imaging device 12. Stacked image data 72 comprises information associated with a stacked image created or otherwise generated by combining or stacking two or more images of image capture data 70. Stacking data 62 comprises information associated with controlling or otherwise generating a stacked image from two or more captured images. For example, in the embodiment illustrated in FIG. 1, stacking data 62 comprises a stacking quantity 76 indicating a quantity of images to combine or stack to form a stacked image.

In operation, image stacking application 42 enables a user to perform an image stacking operation via imaging device 12. For example, in some embodiments of the present invention, user interface 24 is accessed by the user to activate or initiate image stacking application 42. In some embodiments of the present invention, image stacking application 42 is configured to automatically stack two or more images captured using imaging device 12. However, it should be understood that in other embodiments of the present invention, imaging stacking application 42 is configured to enable the user to manually select or otherwise identify particular images captured by imaging device 12 to use during an image stacking operation. Thus, in some embodiments of the present invention, user interface 24 is accessed by a user of imaging device 12 to identify a quantity of images to be captured by imaging device 12 and combined or stacked to create or otherwise generate a stacked image. The quantity of images to capture and/or combine to create or generate a stacked image is stored as stacking quantity 76. Thus, in response to receiving stacking quantity 76, image stacking application interfaces with image capture controller 40 to initiate the capturing of a particular quantity of images designated by stacking quantity 76 and, in turn, image stacking application 42 automatically stacks or otherwise combines the captured images to create or otherwise generate a stacked image, which may be stored as stacked image data 72.

Thus, for a scanner type of imaging device 12, image stacking application 42 interfaces with image capture controller 40 to cause imaging module 22 to perform a quantity of scanning operations to generate or otherwise capture a quantity of images of an object as indicated by stacking quantity 76. It should be understood that for other types of imaging devices 12, imaging module 22 is otherwise controlled to perform an image capture operation based on the type of imaging device 12 (e.g., for a still photography camera, a quantity of shutter releases or exposures as indicated by stacking quantity 76).

In some embodiments of the present invention, image stacking application 42 automatically generates the stacked image after receiving or otherwise acquiring at least two captured images and updates the stacked image as each subsequent captured image is acquired. Thus, in this embodiment of the present invention, it should be appreciated that less memory 30 capacity is used for storing image capture data 70. However, it should be understood that in other embodiments of the present invention, image stacking application 42 is configured to generate the stacked image after acquiring all captured images. Further, in other embodiments of the present invention, image stacking application 42 is configured to enable the user to select or otherwise identify particular captured images to use for the stacking operation. For example, in this embodiment of the present invention, image stacking application 42 is configured to enable a user to view the captured images, such as via user interface 24, to select or otherwise identify the captured images to use during a stacking operation. After selection of particular captured images, image stacking application 42 generates the stacked image using the selected captured images.

FIG. 2 is a flow diagram illustrating an embodiment of an imaging method in accordance with the present invention. The method begins at block 100, where imaging device 12 receives an image stacking request. For example, as described above, the image stacking request may be received from a user via user interface 24. At block 102, imaging device 12 requests identification of stacking quantity 76 from the user indicating the quantity of captured images to be used in the stacking operation. At block 104, imaging device 12 receives user input indicating stacking quantity 76, for example, via user interface 24. At block 106, image stacking application 42 initiates a stacking count corresponding to the input stacking quantity 76. However, it should be understood that image stacking application 42 may be otherwise configured for determining or otherwise identifying stacking quantity 76. For example, in some embodiments of the present invention, image stacking application 42 is configured to provide a default stacking quantity 76 which may be factory preset or set by a user. Additionally, in some embodiments of the present invention, the default stacking quantity 76 is displayed or otherwise presented to the user to enable the user to accept or change the stacking quantity 76.

At block 108, image stacking application 42 interfaces with image capture controller 40 to initiate an image capture operation, for example, using imaging module 22. At block 110, image stacking application 42 decrements the stacking quantity count after acquisition of an image. At decisional block 112, a determination is made whether the stacking quantity count equals zero, thereby indicating that the image capturing and/or stacking operation is complete. If the image capturing and/or stacking operation is not yet complete, the method proceeds to block 114 where another image capture operation is initiated and/or otherwise performed At block 116, image stacking application 42 accumulates the image captures to create or otherwise generate the stacked image and, at block 117, image stacking application 42 generates the stacked image. The image stacking operation may be performed and/or configured using a variety of different methods. For example, in some embodiments of the present invention, an extended bit-depth array may be used for averaging the results of individual image captures (e.g., each scanned image comprising three bytes per pixel (each byte storing red, blue and green values for a pixel) and the accumulated image comprising six bytes per pixel (two bytes each storing red, blue and green values for a pixel)). However, it should be understood that other imaging methods may also be used to accumulate or otherwise form the stacked image. Additionally, in the embodiment of the present invention illustrated in FIG. 2, the stacked image is generated after receiving or otherwise acquiring at least two captured images and is updated as each subsequent captured image is acquired. However, it should be understood that in other embodiments of the present invention, image stacking application 42 is configured to generate the stacked image after acquiring all captured images. The method then proceeds to block 110.

If, at decisional block 112, a determination is made that the image capturing and/or stacking operation is complete, the method proceeds to block 118, where image stacking application 42 returns or otherwise provides the user with stacked image data 72 representing the stacked image. For example, the stacked image data 72 may be provided to the user in high-bit-depth form or the pixel values may be rounded to provide lower-bit-depth results. However, it should be understood that other methods may also be used to provide the user with the resulting stacked image.

Thus, embodiments of the present invention enable a user to easily and automatically perform an image stacking operation via an imaging device. For example, in a scanner type of imaging device, the user may place an object against a platen or other surface for scanning and designate a quantity of scans to use for creating a stacked image. Based on the designated quantity, system 12 automatically initiates the designated quantity of scanning operations and automatically generates the stacked image using the acquired scans.

Embodiments of the present invention may be implemented in software and can be adapted to run on different platforms and operating systems. In particular, functions implemented by image stacking application 42 may be provided as an ordered listing of executable instructions that can be embodied in any computer-readable medium for use by or in connection with an instruction execution system, apparatus, or device, such as a computer-based system, processor-containing system, or other system that can fetch the instructions from the instruction execution system, apparatus, or device, and execute the instructions. In the context of this document, a “computer-readable medium” can be any means that can contain, store, communicate, propagate or transport the program for use by or in connection with the instruction execution system, apparatus, or device. The computer-readable medium can be, for example, but is not limited to, an electronic, magnetic, optical, electromagnetic, infrared, or semi-conductor system, apparatus, device, or propagation medium.

It should also be understood that in other embodiments of the method of the present invention described in FIG. 2, certain functions may be omitted, combined, or accomplished in a sequence different than depicted in FIG. 2. Also, it should be understood that the method depicted in FIG. 2 may be altered to encompass any of the other features or aspects described elsewhere in the specification.

What is claimed is:

1. An imaging system, comprising:
an imaging device adapted to capture a plurality of images of an object; and
a stacking application stored on the imaging device and adapted to generate a stacked image from the plurality of images.

2. The system of claim 1, the imaging device adapted to receive user input indicating a quantity of the plurality of images to stack.

3. The system of claim 1, the imaging device adapted to receive user input indicating a quantity of images to capture for stacking.

4. The system of claim 1, the imaging device consisting of at least one of a camera, a copier, and a scanner.

5. The system of claim 1, the imaging device having a user interface adapted to enable a user to initiate the stacking application.

6. The system of claim 1, the stacking application adapted to request user input indicating a quantity of images to capture for stacking.

7. The system of claim 1, the stacking application adapted to automatically generate the stacked image from the plurality of images.

8. The system of claim 1, the stacking application adapted to generate the stacked image from an extended bit-depth array of the plurality of images.

9. The system of claim 1, the stacking application adapted to generate the stacked image in response to capturing at least two of the plurality of images.

10. The system of claim 1, the stacking application adapted to update the stacked image in response to capturing another image of the plurality of images.

11. The system of claim 1, the stacking application adapted to generate the stacked image from the plurality of images after capturing a user-designated quantity of images.

12. An imaging system, comprising:
means for capturing a plurality of images of an object; and
means, stored on the capturing means, for generating a stacked image from the plurality of images.

13. The system of claim 12, further comprising means for receiving user input indicating a quantity of images to stack.

14. The system of claim 12, further comprising means for requesting user input indicating a quantity of images to stack.

15. The system of claim 12, the stacking means comprising means for generating the stacked image from the plurality of images after capturing at least two of the plurality of images.

16. The system of claim 12, further comprising means for updating the stacked image in response to capturing another image of the plurality of images.

17. An imaging method, comprising:
initiating a stacking application stored on an image capturing device;
capturing a plurality of images via the image capturing device; and
generating a stacked image on the image capturing device from the plurality of images via the stacking application.

18. The method of claim 17, further comprising requesting user input indicating a quantity of images to be stacked.

19. The method of claim 17, further comprising receiving user input indicating a quantity of images to be stacked.

20. The method of claim 17, further comprising generating a stacked image after capturing at least two of the plurality of images.

21. The method of claim 17, further comprising updating a stacked image in response to receiving another image of the plurality of images.

22. The method of claim 17, wherein capturing a plurality of images comprises capturing a predetermined quantity of images as indicated by user input.

23. The method of claim 17, wherein generating a stacked image comprises generating a stacked image from an extended bit-depth array of the plurality of images.

24. The method of claim 17, wherein generating a stacked image comprises automatically generating a stacked image from the plurality of images.

25. The method of claim 17, wherein initiating a stacking application comprises initiating a stacking application disposed on at least one of a camera, a copier and a scanner.

26. A computer-readable medium having stored thereon an instruction set to be executed, the instruction set, when executed by an instruction execution system, causes the instruction execution system to:
cause an imaging device to capture a plurality of images of an object; and
generate, via the imaging device, a stacked image from the plurality of images.

27. The computer-readable medium of claim 26, wherein the instruction set, when executed by the instruction set execution system, causes the instruction set execution system to request user input indicating a quantity of images to capture for stacking.

28. The computer-readable medium of claim 26, wherein the instruction set, when executed by the instruction set execution system, causes the instruction set execution system to automatically generate the stacked image from the plurality of images.

29. The computer-readable medium of claim 26, wherein the instruction set, when executed by the instruction set execution system, causes the instruction set execution system to generate the stacked image in response to capturing at least two of the plurality of images.

30. The computer-readable medium of claim 26, wherein the instruction set, when executed by the instruction set execution system, causes the instruction set execution system to update the stacked image in response to capturing another image of the plurality of images.

31. The computer-readable medium of claim 26, wherein the instruction set, when executed by the instruction set execution system, causes the instruction set execution system to generate the stacked image from the plurality of images after capturing a user-designated quantity of images.
